(19) United States
(12) Patent Application Publication
(10) Pub. No.: US 2007/0058624 A1
(43) Pub. Date: Mar. 15, 2007

(54) Method for controlling packet forwarding in a routing device

(76) Inventors: Yun Ma, Guangdong (CN); Haitao Cai, Guangdong (CN)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/327,030

(22) Filed: Jan. 6, 2006

Related U.S. Application Data
(63) Continuation-in-part of application No. PCT/CN04/00747, filed on Jul. 5, 2004.

(30) Foreign Application Priority Data
Jul. 6, 2003 (CN) 03147319.9

(51) Int. Cl. H04L 12/56

(52) U.S. Cl. 370/389

(57) ABSTRACT

The present invention discloses a method for implementing packet forwarding control in routing device, comprising: said routing device getting a source address of a received packet and judging whether said source address is a legal source address; if it is a legal source address, confirming said packet to be a legal packet, and processing said packet with a normal process flow, and otherwise, confirming said packet to be an illegal packet and proceeding to Step b; and said routing device implementing forwarding control for said packet. The present invention solves the problems in the prior art when controlling packet forwarding, such as resource occupation and degradation of processing capability of network communication devices caused by adding data structures or increasing system overheads. The present invention provides a method for controlling packet forwarding, saving the resource of network communication equipment, improving the processing ability of the network communication equipment, and enhancing the security of the network.

### FIELD OF THE TECHNOLOGY

The present invention relates to network communication technologies, more particularly to a method for implementing packet forwarding control in routing device.

### BACKGROUND OF THE INVENTION

Along with the rapid development of computer technology, computer network has gone deep into our daily life and work. When people use a computer for communications, entertainments or work, it is possible for some network terminal users to transmit illegal packets through the computer so as to attack the communication network. In general, a packet sent by a network terminal user must pass through device with routing function, that is the packet must be forwarded by the device, before reaching its destination, therefore, how a routing device, as a very important device in a communication network, controls the forwarding of packets received by itself has become an important issue.

Each routing device has a destination address routing table for determining the forwarding path of packets stored therein. The routing device determines the forwarding path of the packets according to said destination address routing table. More specifically, when a packet generated by the routing device itself or received from other devices is to be forwarded through one of the interfaces of the routing device, the forwarding procedure may be as follows: matching the destination address routing table in the routing device according to the destination address of the packet to get an output interface corresponding to the destination address, and then forwarding the packet through the output interface.

Packets to be forwarded by the routing device can be an IP packet. In the following, an IP packet is taken as an example, and the forwarding flow of the IP packet is further described with reference to FIG. 1.

The network shown in FIG. 1 includes Networks A, B and C, and a routing device D, the three networks are all connected with the routing device D directly, and the IP packets are forwarded through the routing device D.

Since the Network A connects to the routing device D directly, the destination address routing table of the routing device D must have route to the Network A therein, and the route indicates the interface of the routing device D that connects to the Network A, i.e. the output interface to the Network A in the destination address routing table. Similarly, the destination address routing table of the routing device D also has the routes to the Networks B and C and indicating the corresponding interfaces stored therein. Table 1 shows part of items and records of the destination address routing table in the routing device D.

TABLE 1

| Destination Address | Type of Routing | Output Interface |
|---|---|---|
| Network A | Direct routing | Interface 1 |
| Network B | Direct routing | Interface 2 |
| Network C | Direct routing | Interface 3 |

If a network terminal with an IP address 1.1.1.1 in the Network A sends an IP packet to a network terminal with an IP address 3.3.3.3 in the Network C, the source address of the packet is 1.1.1.1 and the destination address of the packet is 3.3.3.3. When the IP packet arrives at the routing device D through Network A, the routing device D matches the destination IP address 3.3.3.3 of the packet with the destination addresses in its destination address routing table. Since the address 3.3.3.3 is an IP address in Network C, it can be determined that the output interface of the packet is the “interface 3”, according to the destination address routing table, the routing device D transmits the IP packet via the “interface 3” so as to finish forwarding the IP packet.

As mentioned above, some network terminal users may transmit illegal IP packets to attack the network. A usual way for those users to attack the network is: IP address deception, i.e. the users modify the source address of the sent IP packets by some means into another IP address to deceive the attacked network. In practice, the attacker usually forges an IP address of the network to be attacked or forges a legal IP address of a certain trusty external network of the network to be attacked and uses this address as the source IP address to gain trust of the network to be attacked. Thereby, the packet with the forged source IP address can pass the routing devices and be forwarded to the attacked users.

Specifically, an illegal IP packet may be sent by a network terminal forging a broadcast address as the source address of the IP packet sent. If the IP packet needs a response, after receiving the packet, the recipient will broadcast the packet over the whole network with the broadcast address of the packet as destination addresses. For the routing device, after the recipient responds to the IP packet, the routing device will copy and broadcast the IP packet sent by the recipient according to the broadcasting scope relating to the interface designated in the destination address routing table, this not only disturbs the data transmission in the part of the network corresponding to the destination address, but also affects the performance of the routing device.

In addition, the routing device usually adopts black-hole route policy or refused route policy i.e. sets some routes as black-hole routes or refused routes, in order to limit the forwarding of packets aiming at some given destination addresses. When the routing device deals with the packets with these two types of routing, some system resources are consumed, therefore, if the source IP address of the IP packet sent by the network terminal user is forged and the corresponding route of the forged IP address in the destination address routing table of the routing device is a black-hole route or a refused route, there will be an impact on the routing device when the recipient responses to the IP packet, especially when there are a lot of packets to be forwarded.

It is possible as well for a network terminal user to forge the source address of an IP packet as a destination address corresponding to the loop type of routing. Since the loop route is a test means of the routing device itself, and the packet with this type of route should only be generated within the routing device, IP packets with such a source address should not be forwarded by the routing device.

It is also possible for a network terminal user to forge the source address of an IP packet as a destination address corresponding to the broadcast type of routing. Similar to the case that the source address is forged as a broadcast address; such packets should not be forwarded by the routing device.

At present, a method for preventing a network being attacked by source IP address deception is to increase data structures or system overheads in the routing device. Though the forwarding packets with illegal source addresses can be controlled by the increased data structures or system overheads, more resources of the network communication system has to be occupied, and the handling performance of the network communication device is lowered.

### SUMMARY OF THE INVENTION

In view of the above, a main object of the present invention is to provide a method for packet forwarding control in routing device so as to implement forwarding control to the illegal packets using source addresses other than the addresses of the transmitting terminal without increasing data structures in the routing device.

To attain the above object, the method of the present invention comprises the following steps:

(a) routing device getting a source address of a received packet and judging whether said source address is a legal source address; if it is a legal source address, confirming said packet to be a legal packet, and processing said packet with a normal process flow, and otherwise, confirming said packet to be an illegal packet and proceeding to Step b; and

(b) said routing device implementing forwarding control for said packet..

In accordance with the method of the present invention, whether a packet to be forwarded by a routing device is legal or not is determined by deciding whether the source address of the packet is legal, and the forwarding of illegal packets is accordingly controlled. By adopting this method, the forwarding of the packets can be controlled without adding data structures or increasing system overheads, that is, the activities of source address deception by an accessed user can be stopped. When a routing device acts as an access server, the activities of source address deception by an accessed user can be totally eliminated. As a result, the resources of network communication equipment are saved, the performance of the network communication equipment is improved, and the network security is enhanced.

### BRIEF DESCRIPTION OF THE DRAWINGS

FIG. 1 is a schematic diagram illustrating the connection in a communication network in the prior art;

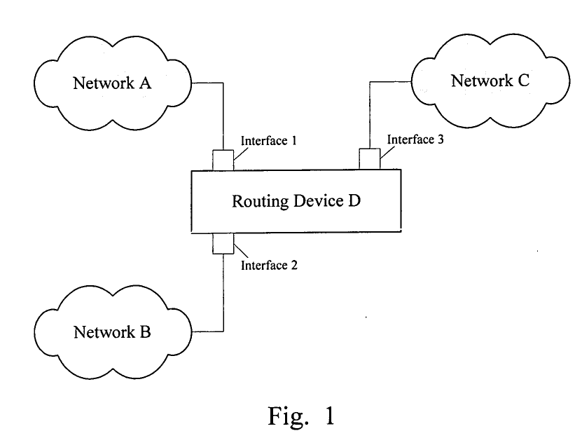

FIG. 2 shows the flowchart of an embodiment of the present invention.

### DETAILED DESCRIPTION OF THE INVENTION

In accordance with the method of the present invention, a routing device will decide whether a packet is legal or not by deciding whether the source address of the packet to be forwarded is legal or not, and then control the forwarding of the illegal packets so as to stop the activities of source address deception by an accessed user.

A preferred embodiment of the present invention will be described hereinafter in detail with reference to the accompanying drawing. Since the packet related to the present invention can be an IP packet, an IP packet is taken as an example to describe this embodiment.

Since the source IP address of the IP packet sent by the network terminal users should be a legal unicast address, when the source IP address of the network terminal users is a broadcast address, it means that the source IP address of the IP packet is a forged source IP address, i.e. the packet is an illegal packet; therefore the routing device should discard the IP packet with a broadcast address as its source IP address.

In addition, if the source IP address of the IP packet sent by the network terminal user is assumed as a destination address, the route corresponding to this destination address should be an existing route, and the type of this route should not be that of a black-hole route, a refused route, a broadcast route or a loop route.

Based on the above description, whether an IP packet is a legal packet can be determined by the source address of the packet. More specifically, taking the source IP address of the IP packet sent by the network terminal user as a destination address, determining whether there is a route corresponding to the source IP address of the IP packet by the existing destination address routing table of the routing device, and if there is, determining whether the existing route is a black-hole route, a refused route, a broadcast route, and a loop route. If the route corresponding to the source IP address exists, and it is not a black-hole route, nor a refused route, nor a broadcast route, nor a loop route, then the IP packet is considered as a legal packet; otherwise, the packet is illegal and should be discarded.

In practice, the network terminal user may embezzle the IP address of another legal user and use the IP address as the source IP address of the packets forwarded by it. In this case, it is necessary to further judge whether this legal source IP address is an embezzled legal source IP address. Since the routing device, when forwarding a packet, will create a forwarding route according to the self-stored destination address routing table and the destination address of the IP packet, and determine a pre-set output interface, the specific method for checking whether the legal IP address is embezzled when forwarding the packet with this legal IP address comprises the following steps: taking the source IP address of the IP packet sent by the network terminal user as the destination address of an IP packet, and determining the corresponding output interface according to this destination address and the self-stored destination address routing table, if said output interface is not the input interface through which the network terminal user sent the IP packet to the routing device, it is indicated the source IP address of the IP packet sent by the network terminal user is an embezzled legal address, and the IP packet is discarded by the routing device.

It can be seen from the above description that, in accordance with the present invention, forwarding control of the IP packet in the routing device is implemented by means of adding an operation of searching the matched route in the existing destination address routing table of the routing device according to the source IP address of the IP packet. The method of the present invention is implemented simply and easily, it just occupies few resources of the routing device and generally has no impact on the processing capability of the routing device.

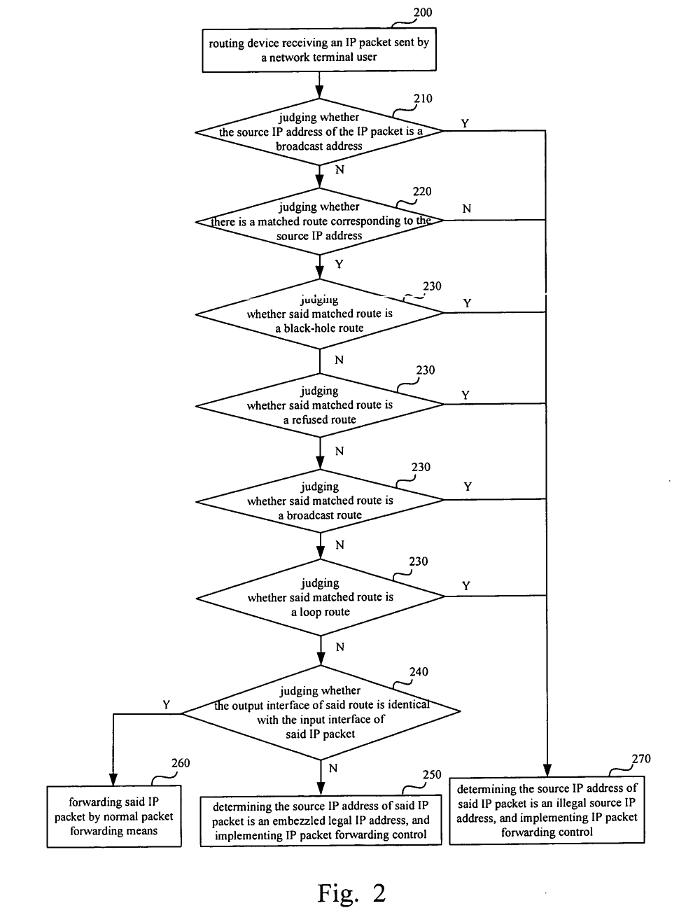

With reference to the flowchart shown in FIG. 2, the implementing procedure of a preferred embodiment of the present invention is hereinafter further described, comprising the following steps:

Step 200: the routing device receiving the IP packet sent by the network terminal user.

Step 210: the routing device judging whether the source IP address of the received IP packet is a broadcast address; if it is, proceeding to Step 270, and otherwise, proceeding to Step 220.

Step 220: the routing device judging whether there exists a route matched to the source IP address in the destination address items of the destination address routing table; if there is no such a route, proceeding to Step 270, and otherwise, proceeding to Step 230.

Step 230: judging whether the route is a black-hole route, a refused route, a broadcast route or a loop route; if it is a route of one of these types, proceeding to Step 270, and otherwise, proceeding to Step 240.

Step 240: judging whether the output interface of the route is identical with the input interface through which the IP packet enters the routing device; if it is not, proceeding to Step 250, and otherwise, proceeding to Step 260.

Step 250: determining the source IP address of the IP packet to be an embezzled legal IP address, and the routing device controlling the forwarding of the IP packet by discarding the packet or other means.

Step 260: determining the IP packet to be a packet with a legal source IP address. the routing device establishing a forwarding route for the packet and forwarding it by normal packet forwarding means.

Step 270: determining the source IP address of the IP packet is not a legal source IP address, i.e. the IP packet is not a legal packet, thereby the routing device controls the forwarding of the IP packet by discarding the packet or other means.

The main object of the present invention can be attained through the above process.

It should be noted that although, as in FIG. 2, the decisions in connection with black-hole route, refused route, broadcast route and loop route are made in said order, they can be made in any other orders, i.e. the decision in connection with any of the four types of route may be made first.

In using the method provided by the present invention to implement packet forwarding control, since the routes in the destination address routing table stored in an access server are mainly the routes of each accessing user, i.e. the destination address items of the destination address routing table point to the route to a single host computer, not the route in a network, so that if a routing device is an access server, using the method provided by the present invention to implement reverse route tracking can achieve a very high precision, especially to position a network terminal device. By using the method for implementing packet forwarding control in an access server, the activities of source IP address deception by the network terminal user can be totally eliminated, and accordingly, the security of the network can be ensured.

Mentioned above is only an embodiment of the present invention, which should not be taken as limitations to the protective scope of the present invention.

1. A method for implementing packet forwarding control in routing device, comprising the following steps:
(a) routing device getting a source address of a received packet and judging whether said source address is a legal source address; if it is a legal source address, confirming said packet to be a legal packet, and processing said packet with a normal process flow, and otherwise, confirming said packet to be an illegal packet and proceeding to Step b; and
(b) said routing device implementing forwarding control for said packet.

2. The method according to claim 1, wherein step a, said step of judging whether said source address is a legal source address comprises:
said routing device judging whether said source address is a broadcast address, if it is not a broadcast address, confirming said packet to be a legal packet, and otherwise, confirming said packet to be an illegal packet.

3. The method according to claim 1, wherein step a, said step of judging whether said source address is a legal source address comprises:
taking the source address as a destination address, and judging whether a route matching to said destination address exists according to destination address routing table in said routing device, if the route matching to said destination address exists, confirming said packet to be a legal packet, and otherwise, confirming said packet to be an illegal packet.

4. The method according to claim 3, further comprising a step between the step of judging whether a route matching to said destination address exists and the step of confirming said packet to be a legal packet, which comprises:
judging whether said route matching to said destination is a black-hole route, a refused route, a broadcast route, or a loop route, if so, confirming said packet to be an illegal packet, and otherwise, confirming said packet to be a legal packet.

5. The method according to claim 1, wherein step a, said step of judging whether said source address is a legal source address comprises:
said routing device taking said source address as a destination address, obtaining an output interface corresponding to said destination address in a self-stored destination address routing table, and judging whether said output interface is an input interface through which the routing device receives said packet, if so, confirming said packet to be a legal packet, and otherwise, confirming said packet to be an illegal packet.

6. The method according to claim 1, wherein step a, said step of judging whether said source address is a legal source address comprises:
a1. said routing device judging whether the source address is a broadcast address, if it is not a broadcast address, proceeding to step a2, and otherwise, confirming said packet to be an illegal packet;
a2. said routing device taking the source address as a destination address and judging whether a route matching to said destination address exists according to a destination address routing table of the routing device, if so, proceeding to step a3, and otherwise, confirming said source address to be an illegal packet;
a3. said routing device judging whether said route matching to said destination address is a black-hole route, a refused route, a broadcast route, or a loop route, if so, confirming said packet to be an illegal, and otherwise, proceeding to step a4; and
a4. said routing device taking said source address as a destination address, obtaining an output interface corresponding to said destination address in a self-stored destination address routing table, and judging whether said output interface is an input interface through which the routing device receives said packet, if so, confirming said packet to be a legal packet, and otherwise, confirming said packet to be an illegal packet.

7. The method according to claim 1, wherein said step b refers to said routing device not forwarding said packet.

8. The method according to claim 7, wherein said routing device not forwarding said packet refers to discarding said packet.

9. The method according to claim 1, wherein said routing device is any one selecting from a group consisting of an access server and a router.

10. The method according to claim 1, wherein said packet comprises an IP packet.
